(19) United States
(12) Patent Application Publication
(10) Pub. No.: US 2018/0276773 A1
(43) Pub. Date: Sep. 27, 2018

(54) METHOD AND SYSTEM OF USING MILEAGE TICKETS TO TAKE AIRPLANES

(71) Applicant: Kuang-Yao LEE, Richardson, TX (US)

(72) Inventor: Kuang-Yao LEE, Richardson, TX (US)

(21) Appl. No.: 15/468,144

(22) Filed: Mar. 24, 2017

(51) Int. Cl. G06Q 50/14; G06Q 20/28; G06Q 10/02

(52) U.S. Cl. CPC G06Q 50/14; G06Q 10/02; G06Q 20/28

(57) ABSTRACT

A system of using mileage ticket to take airplanes includes: a store for selling mileage tickets; a flight service provider for providing service of using mileage tickets to take airplanes; and a plurality of user ends, each being used by a passenger to purchase a specific amount of mileages from the store. The passenger requests the flight service provider to exchange some of the specific amount of mileages for a desired mileage ticket. The desired mileage ticket involves at least one flight segment provided by at least one airline. The at least one flight segment includes a flight distance between a departure airport and a destination airport. The flight service provider uses the flight distance to directly correspond to an amount of mileages required to purchase the desired mileage ticket. As being based on the distance between two cities, the ticket price is always constant and easy for inquiry.

### BACKGROUND OF THE INVENTION

### 1. Field of the Invention

The present invention relates to a method and system for taking airplanes and, more particularly, to a method and system of using mileage tickets to take airplanes.

### 2. Description of Related Art

Nowadays, money is considered to be the unit for evaluating the value of the airplane tickets. For example, a Taipei/Los Angeles round-trip ticket of economy class costs NTD (New Taiwan Dollar) 48000, while Los Angeles/Taipei round-trip ticket of economy class costs USD (US dollar) 1950, which is more expensive. In this example, the two flights provide the same distances and the same services (such as foods, drinks, environment, and treatment) but require different prices. There are billions of people taking airplane per year in the world. People buy tickets under unequal information, and have no idea about the standard of ticket prices. The system of ticket prices is complicated. The diversity of the rules of airlines causes the price difference and the difficulty in bill settlement among airlines.

Therefore, International Air Transportation Association (IATA) has been founded by the airlines in the world, with the purpose to solve the problem of price difference and bill settlement. However, since there are tens of millions of air routes in the world, and each of the air routes has one or more extended points, as well as travel classes include economy class, business class and first class, there can be more than billions of kinds of ticket prices. This seriously confuses the passengers. For example, it is more expensive to buy a Tokyo/Taipei round-trip ticket in Japan than to buy a Taipei/Tokyo round-trip ticket in Taiwan, even though the tickets involve the same distances and the same services, and the cost of the airplane for this trip is the same. For another example, the price of airplane and gasoline is evaluated by USD. However, when JPY (Japanese Yen) appreciates for 15%, the price of a Tokyo/Taipei round-trip ticket remains unchanged for JPY 60000. This is also confuses passengers and fairness cannot be achieved as price information is not clearly revealed.

Moreover, it is complicated to buy a ticket to travel to several destinations or to travel through several airlines, since not only it needs IATA to designate the complicated prices, types and items, but also it needs a large amount of manpower for data input. It can be understood that, any wrong data input will cause a serious controversy. This shows the difficulty in ticket issuance.

Suppose that a passenger needs to refund a ticket. Since there are many rules of airlines and many kinds of tickets, it is complicated and time-consuming to calculate the refund, and it takes a long time for the passenger to receive the refund. Besides, the passenger cannot check whether he receives the correct amount of the refund. In case that the ticket includes two parts of service provided respectively by two airlines, and a part is used while the other part remains unused, the calculation of the refund of the unused part is even confusing to passengers. For example, the passenger is expected to take EVA Air for a Taipei/San Francisco round-trip, and then to take United Airlines for a San Francisco/Dallas round-trip. However, for some reason, the passenger only uses the part of the ticket for San Francisco/Taipei round-trip (provided by EVA Air), while the other part of the ticket for San Francisco/Dallas round-trip (provided by United Airlines) remains unused. In this case, the calculation for the refund of the unused part is incomprehensible to passengers. Moreover, it is even more difficult to calculate the refund in case of taking United Airlines from San Francisco to Dallas while taking American Airlines from Dallas to San Francisco.

In addition, charging issues for airlines is also considerable. After selling a ticket, the travel agent reserves its own commission, and remits the fee to the bank account assigned by IATA. The fee is used to pay to airline(s) involved in the ticket. After being checked by IATA, the fee is transferred to the airline(s). Even if the ticket involves two or more airlines, IATA only transfers the fee to the major airline that issues the ticket. Then, the airline that issues the ticket transfers parts of the fee to other airlines according to its agreements for air routes concluded with other airlines, or the rules of IATA. However, since there are thousands of airlines in the world, and tens of millions of travel routes, as well as there are special agreements for some flight segments, while none for the others, it is considerable and complicated for airlines to settle their bills, and it usually takes more than one year to settle down the bills for a ticket involving several airlines.

Therefore, it is desired to provide a method and a system of using mileage tickets to take airplanes, so as to alleviate or obviate the aforementioned problems and complexity.

### SUMMARY OF THE INVENTION

The present invention aims to provide a method and system of using mileage tickets to take airplanes, so as to solve the problems encountered in the prior art. In the present invention, the price of a ticket is based on the mileage distance between two cities, such as 511 miles between Taipei and Hong Kong and 422 miles between Taipei and Shanghai, and such distances are never changed. Therefore, the price of the mileage ticket is always constant and easy for inquiry. Furthermore, after the passenger uses the mileage ticket to take airplanes, a store immediately wires the corresponding mileage fees to different airlines, so as to avoid the complicated billing problem and settle down the bills in a few minutes after taking airplanes.

According to a feature of the present invention, there is provided a method of using mileage tickets to take airplanes, including: a passenger purchasing a specific amount of mileages from a store (which can be a travel agency, a ticket office of an airline, or any other ticket agent that sells mileage tickets); the passenger requesting an flight service provider to exchange some of the specific amount of mileages for a desired mileage ticket, wherein the desired mileage ticket involves at least one flight segment provided by at least one airline, and the at least one flight segment includes a flight distance between departing from a departure airport and landing on a destination airport; the flight service provider using the flight distance of the at least one flight segment involved in the desired mileage ticket to directly correspond to an amount of mileages required to purchase the desired mileage ticket; and the flight service provider charging from the passenger the amount of mileages required to purchase the desired mileage ticket, and giving the passenger a right to board the at least one airline corresponding to the desired mileage ticket.

According to another feature of the present invention, there is provided a system of using mileage ticket to take airplanes, including: at least one store for selling mileage tickets; an flight service provider for providing service of using mileage tickets to take airplanes; and a plurality of user ends, each being used by a passenger to purchase a specific amount of mileages from the at least one store, wherein the passenger requests the flight service provider to exchange some of the specific amount of mileages for a desired mileage ticket, the desired mileage ticket involves at least one flight segment provided by at least one airline, the at least one flight segment includes a flight distance between departing from a departure airport and landing on a destination airport, the flight service provider uses the flight distance of the at least one flight segment involved in the desired mileage ticket to directly correspond to an amount of mileages required to purchase the desired mileage ticket, and the flight service provider charges from the passenger the amount of mileages required to purchase the desired mileage ticket, and gives the passenger a right to board the at least one airline corresponding to the desired mileage ticket.

### BRIEF DESCRIPTION OF THE DRAWINGS

FIG. 1 schematically illustrates a system of using mileage tickets to take airplanes according to the present invention;

FIG. 2 shows a flow chart of a method of using mileage tickets to take airplanes according to the present invention;

FIG. 3 schematically illustrates a diagram of flight;

FIG. 4 schematically illustrates a diagram of flight when changing a flight segment;

FIG. 5 schematically illustrates a diagram of flight when canceling a flight segment; and

FIG. 6 schematically illustrates a diagram of flight when changing an airline.

### DETAILED DESCRIPTION OF THE PREFERRED EMBODIMENT

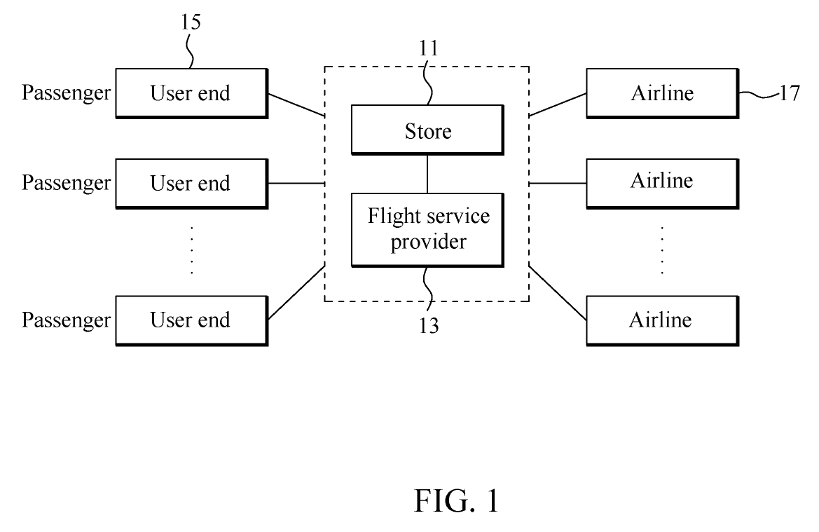

FIG. 1 schematically illustrates the system of using mileage tickets to take airplanes according to the present invention, which includes: at least one store 11, a flight service provider 13, a plurality of user ends 15, and a plurality of airlines 17. The store 11 can be a travel agency, a ticket office of an airline, or any other ticket agent, which sells mileage tickets. The flight service provider 13 is a server end for providing service of using mileage tickets to take airplanes. Each of the user ends 15 can be a cellphone, a laptop computer, or a desktop computer used by the passenger, or a terminal device provided by the store 11. Each of the user ends 15 allows a passenger to buy a specific amount of mileages from the store 11.

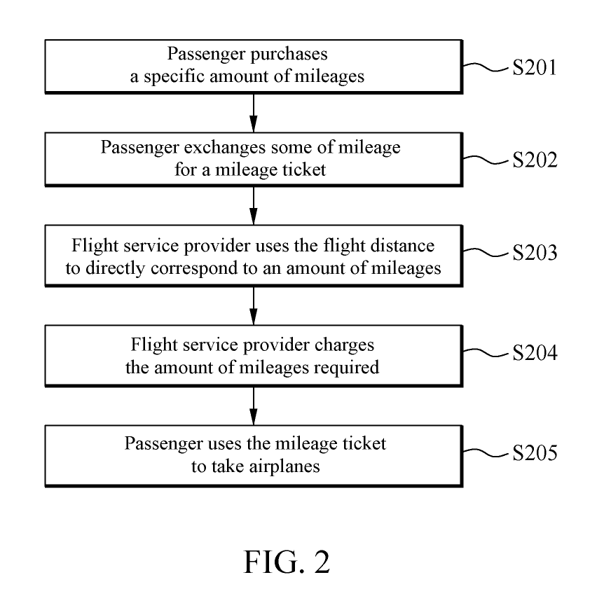

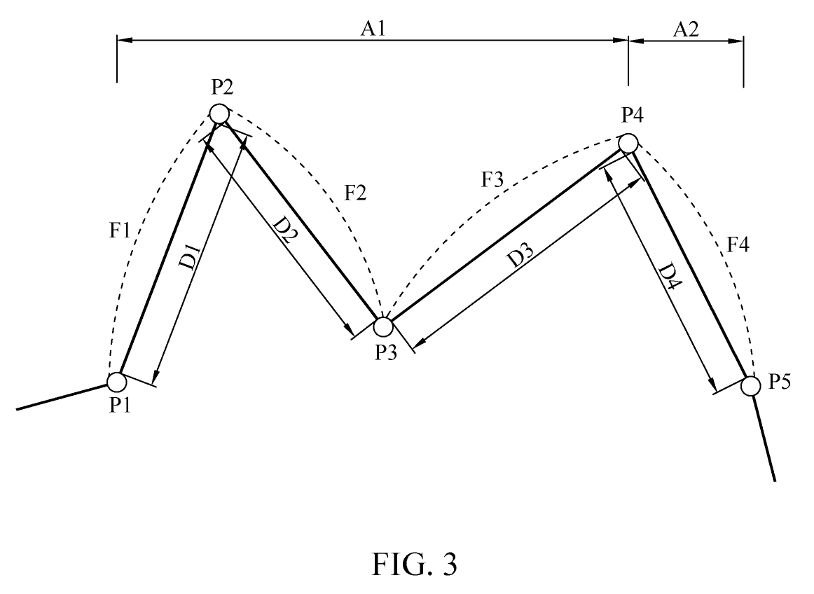

Please refer to FIG. 2, which shows a flow chart of a method of using mileage tickets to take airplanes according to the present invention, and FIG. 3, which schematically illustrates a diagram of flight. First, a passenger uses the user end 15 to purchase a specific amount of mileages from the store 11 (step S201). By this, the passenger has his/her purchased amount of mileages. When the passenger plans to take airplanes, he/she requests the flight service provider 13 to exchange some of his/her mileages for a desired mileage ticket (step S202), wherein the desired mileage ticket involves at least one flight segment provided by at least one airline, and the flight segment is representative of a flight distance between departing from a departure airport and landing on a destination airport. As shown in FIG. 3, the desired mileage ticket for the passenger involved a flight segment F1 provided by an airline A1, a flight segment F2 provided by the airline A1, a flight segment F3 provided by the airline A1, and a flight segment F4 provided by an airline A2, wherein the flight segment F1 includes a flight distance between departing from a departure airport P1 and landing on a destination airport P2, the flight segment F2 includes a flight distance between departing from a departure airport P2 and landing on a destination airport P3, the flight segment F3 includes a flight distance between departing from a departure airport P3 and landing on a destination airport P4, and the flight segment F4 includes a flight distance between departing from a departure airport P4 and landing on a destination airport P5.

Next, the flight service provider 13 uses the flight distance of the at least one segment involved in the desired mileage ticket to directly correspond to an amount of mileages required to purchase the desired mileage ticket (Step S203), wherein using the flight distance of the at least one segment involved in the desired mileage ticket to directly correspond to an amount of mileages required to purchase the desired mileage ticket preferably represents that the amount of mileages required to purchase the desired mileage ticket is equal to a mileage value of the flight distance. By taking FIG. 2 as an example, the amount of mileages required to purchase the desired mileage ticket is M=D1+D2+D3+D4, wherein D1 is an actual flight distance (in terms of mileage) of the flight segment F1, D2 is an actual flight distance (in terms of mileage) of flight segment F2, D3 is an actual flight distance (in terms of mileage) of flight segment F3, and D4 is an actual flight distance (in terms of mileage) of flight segment F4. Accordingly, the flight service provider 13 charges from the passenger the amount of mileages required to purchase the desired mileage ticket, and gives the passenger the right to board the at least one airline corresponding to the desired mileage ticket (step S204). Then, the passenger can use the mileage ticket to take airplanes (step S205), departing from the airport P1, through the airports P2, P3 and P4, and arriving on the airport P5.

In the aforementioned embodiment, the desired mileage ticket involves four flight segments, and it can be understood that, the number is not used to limit the present invention. In other embodiments, the desired mileage ticket may include one to three segments, or more than four segments. The amount of mileages required to purchase the desired mileage ticket can be calculated similar to the aforementioned embodiment, and thus a detailed description therefor is deemed unnecessary.

Moreover, in the aforementioned embodiment, the four flight segments involved in the desired mileage ticket can be provided by two airlines A1 and A2, and it can be understood that, the number is not used to limit the present invention. In other embodiments, the flight segments involved in the desired mileage ticket can be provided by one airline, or more than two airlines. In the present invention, since the flight distance directly corresponds to the amount of mileages required to purchase the desired mileage ticket, the number of the airlines involved in the mileage ticket does not influence the calculation of the amount of mileages required to purchase the desired mileage ticket.

Nowadays, the ticket prices are defined by money, and thus, when airlines in different countries are involved in a travel, the exchange between different currencies becomes an issue. For example, NTD is used when departing from Taipei and JPY is used when departing from Japan, while EUR (Euro) is used when departing from Europe. The price issue is complicated and must be handled by IATA and, when the price fluctuates due to some reason (such as oil prices), it becomes even more complicated. However, if ticket prices are defined by mileages, since the distance between two cities never changes, the issue becomes simple. With a price table published on a website, all consumers can easily acquire prices of flight segments.

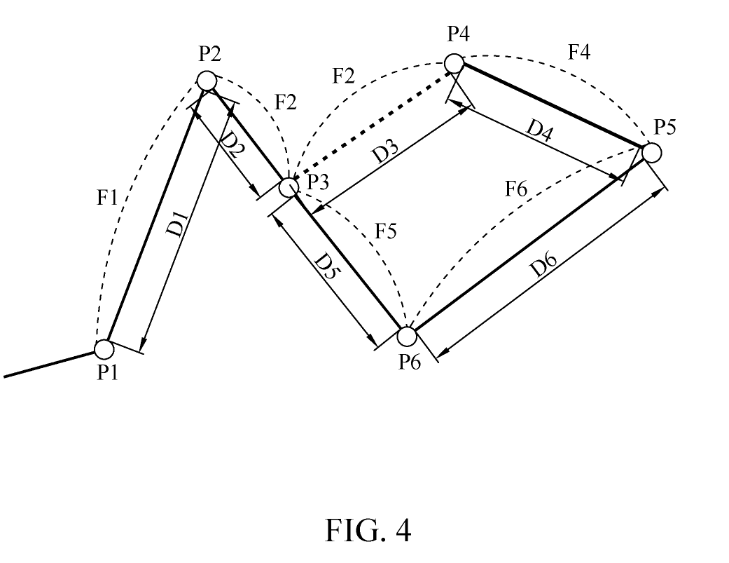

Suppose that, for some reason, the passenger needs to change at least one flight segment after purchasing the mileage ticket. Please refer to the diagram of flight when changing a flight segment shown in FIG. 4, wherein the passenger with the original mileage ticket is expected to depart from an airport P1, travel through airports P2, P3, P4, and arrive on an airport P5. The mileage ticket involves flight segments F1, F2, F3 and F4, and the amount of mileages required to purchase the original mileage ticket is M=D1+D2+D3+D4. For some reason, such as weather, the passenger requests to change the flight segments F3 and F4 to an alternative flight segment, which includes a flight subsegment F5 and a flight subsegment F6, wherein the flight subsegment F5 includes a flight distance (in terms of mileage) between departing from a departure airport P3 and landing on a destination airport P6, and the flight subsegment F6 includes a flight distance (in terms of mileage) between departing from a departure airport P6 and landing on a destination airport P5. Accordingly, the flight service provider 13 returns to the passenger the mileages D3 and D4 of the flight segments F3 and F4, and charges from the passenger the mileages D5 and D6 of the flight subsegment F5 and the flight subsegment F6 in the alternative flight segment. By doing this, with no complicated reissue ticket process, the mileages required to purchase the new mileage ticket can be immediately known as M′=M−D3−D4+D5+D6.

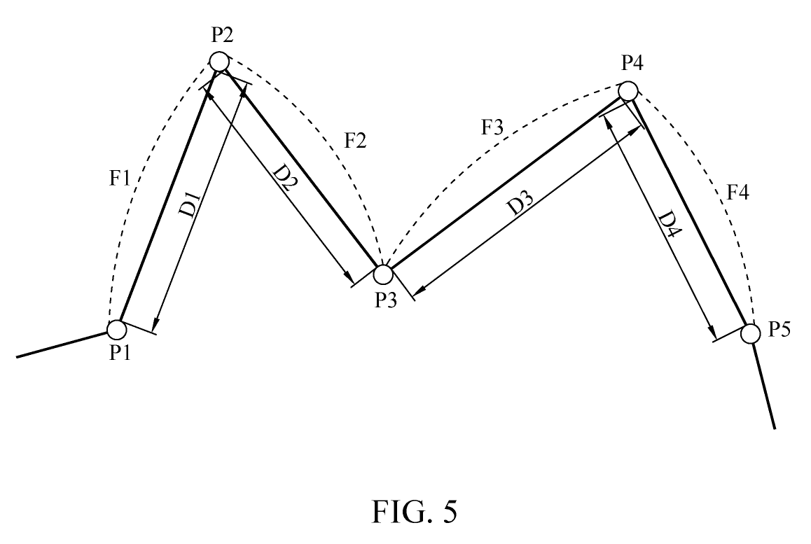

Suppose that, for some reason, the passenger needs to cancel at least one flight segment after purchasing the mileage ticket. Please refer to the diagram of flight when canceling a flight segment shown in FIG. 5, wherein the passenger with the original mileage ticket is expected to depart from an airport P1, travel through airports P2, P3, P4, and arrive on an airport P5. The mileage ticket involves flight segments F1, F2, F3 and F4, and the amount of mileages required to purchase the original mileage ticket is M=D1+D2+D3+D4. For some reason, such as courses changed, the passenger requests to cancel the flight segment F4. Accordingly, the flight service provider 13 returns to the passenger the mileages D4 of flight segment F4. By doing this, with no complicated reissue ticket process, the amount of mileages required to purchase the new mileage ticket can be immediately known as M′=M-D4.

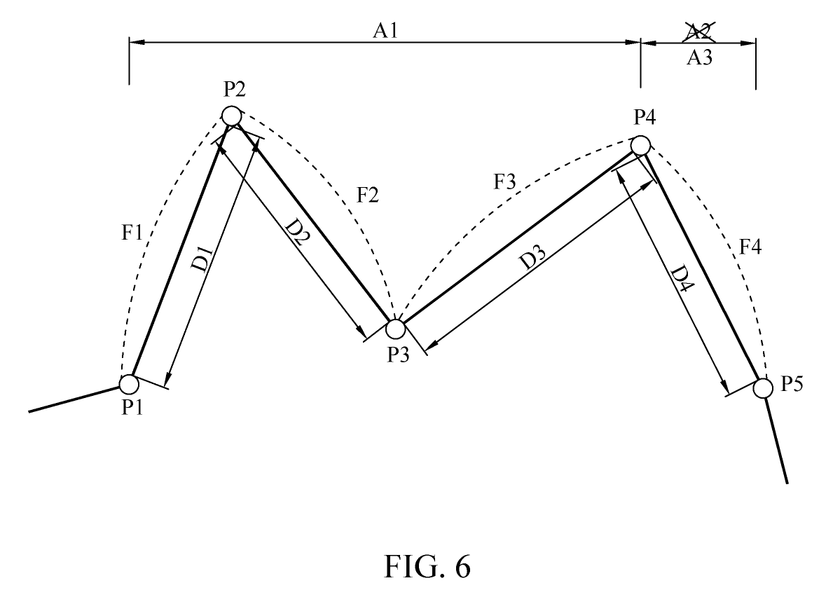

Suppose that, for some reason, the passenger needs to change an airline providing at least one flight segment after purchasing the mileage ticket. Please refer to the diagram of flight when changing an airline shown in FIG. 6, wherein the passenger with the original mileage ticket is expected to depart from an airport P1, travel through airports P2, P3, P4, and arrive on an airport P5. The mileage ticket involves flight segment F1, F2, F3 and F4, wherein the flight segments F1, F2 and F3 are provided by an airline A1 and the flight segment F4 is provided by an airline A2, and the amount of mileages required to purchase the original mileage ticket is M=D1+D2+D3+D4. For some reason, such as airline adjustment, the passenger requests to change the provider of flight segment F4 from the airline A2 to an airline A3. As a result, since the mileages D4 of the flight segment F4 remain unchanged, it is unnecessary to change the amount of mileages required to purchase a new mileage ticket, and there is no need to perform the complicated reissue ticket process, while simply transferring the payment for the mileages of the flight segment F4 from the airline A2 to the airline A3.

According to the method and system of using mileage tickets to take airplanes of the present invention, the unit for evaluating a mileage ticket is the distance between two cities (airports) and the distance between two cities never changes. Therefore, billions of passengers taking airplane per year can clearly know and handle the ticket prices. Besides, it is clearer and simpler to check the flow of money for buying the tickets, and it is also easier to change or cancel a flight segment or change an airline providing a flight segment. Furthermore, after the passenger uses the mileage ticket to take airplanes, the store immediately wires the corresponding mileage fees to different airlines, so as to avoid the complicated billing problem and settle down the bills in a few minutes after taking airplanes.

Although the present invention has been explained in relation to its preferred embodiments, it can be understood that, many other possible modifications and variations can be made without departing from the spirit and scope of the invention as hereinafter claimed.

What is claimed is:

1. A method of using mileage tickets to take airplanes, including:
a passenger purchasing a specific amount of mileages from a store;
the passenger requesting an flight service provider to exchange some of the specific amount of mileages for a desired mileage ticket, wherein the desired mileage ticket involves at least one flight segment provided by at least one airline, and the at least one flight segment includes a flight distance between departing from a departure airport and landing on a destination airport;
the flight service provider using the flight distance of the at least one flight segment involved in the desired mileage ticket to directly correspond to an amount of mileages required to purchase the desired mileage ticket; and
the flight service provider charging from the passenger the amount of mileages required to purchase the desired mileage ticket, and giving the passenger a right to board the at least one airline corresponding to the desired mileage ticket.

2. The method of using mileage tickets to take airplanes as claimed in claim 1, wherein using the flight distance to directly correspond to an amount of mileages required to purchase the desired mileage ticket is making the amount of mileages required to purchase the desired mileage ticket equal to a mileage value of the flight distance.

3. The method of using mileage tickets to take airplanes as claimed in claim 2, wherein the desired mileage ticket involves a plurality of flight segments, each including a flight distance between departing from a departure airport and landing on a destination airport, and the amount of mileages required to purchase the desired mileage ticket directly corresponds to a summation of the flight distances of the flight segments.

4. The method of using mileage tickets to take airplanes as claimed in claim 3, wherein the flight segments are provided by one airline.

5. The method of using mileage tickets to take airplanes as claimed in claim 3, wherein the flight segments are provided by at least two different airlines.

6. The method of using mileage tickets to take airplanes as claimed in claim 3, wherein, when the passenger requests to change at least one flight segment of the plurality of flight segments to an alternative flight segment, the flight service provider returns to the passenger the mileages directly corresponding to the flight distance of the at least one flight segment to be changed, and charges from the passenger the mileages directly corresponding to the flight distance of the alternative flight segment, in which the alternative flight segment includes at least one flight subsegment.

7. The method of using mileage tickets to take airplanes as claimed in claim 3, wherein, when the passenger requests to cancel at least one flight segment of the plurality of flight segments, the flight service provider returns to the passenger the mileages directly corresponding to the flight distance of the at least one flight segment to be cancelled.

8. The method of using mileage tickets to take airplanes as claimed in claim 3, wherein, when the passenger requests to change the airline providing the at least one flight segment of the plurality of flight segments, the flight service provider does not change for the passenger the amount of mileages directly corresponding to the flight distance of the at least one flight segment, and reassigns to the passenger a mileage ticket with the changed airline.

9. A system of using mileage ticket to take airplanes, including:
at least one store for selling mileage tickets;
an flight service provider for providing service of using mileage tickets to take airplanes; and
a plurality of user ends, each being used by a passenger to purchase a specific amount of mileages from the at least one store,
wherein the passenger requests the flight service provider to exchange some of the specific amount of mileages for a desired mileage ticket, the desired mileage ticket involves at least one flight segment provided by at least one airline, the at least one flight segment includes a flight distance between departing from a departure airport and landing on a destination airport, the flight service provider uses the flight distance of the at least one flight segment involved in the desired mileage ticket to directly correspond to an amount of mileages required to purchase the desired mileage ticket, and the flight service provider charges from the passenger the amount of mileages required to purchase the desired mileage ticket, and gives the passenger a right to board the at least one airline corresponding to the desired mileage ticket.

10. The system of using mileage tickets to take airplanes as claimed in claim 9, wherein using the flight distance to directly correspond to an amount of mileages required to purchase the desired mileage ticket is making the amount of mileages required to purchase the desired mileage ticket equal to a mileage value of the flight distance.

11. The system of using mileage tickets to take airplanes as claimed in claim 10, wherein the desired mileage ticket involves a plurality of flight segments, each including a flight distance between departing from a departure airport and landing on a destination airport, and the amount of mileages required to purchase the desired mileage ticket directly corresponds to a summation of the flight distances of the flight segments.

12. The system of using mileage tickets to take airplanes as claimed in claim 11, wherein the flight segments are provided by one airline.

13. The system of using mileage tickets to take airplanes as claimed in claim 11, wherein the flight segments are provided by at least two different airlines.

14. The system of using mileage tickets to take airplanes as claimed in claim 11, wherein, when the passenger requests to change at least one flight segment of the plurality of flight segments to an alternative flight segment, the flight service provider returns to the passenger the mileages directly corresponding to the flight distance of the at least one flight segment to be changed, and charges from the passenger the mileages directly corresponding to the flight distance of the alternative flight segment, in which the alternative flight segment includes at least one flight subsegment.

15. The system of using mileage tickets to take airplanes as claimed in claim 11, wherein, when the passenger requests to cancel at least one flight segment of the plurality of flight segments, the flight service provider returns the mileages directly corresponding to the flight distance of the at least one flight segment to be cancelled.

16. The system of using mileage tickets to take airplanes as claimed in claim 11, wherein, when the passenger requests to change the airline providing the at least one flight segment of the plurality of flight segments, the flight service provider does not change for the passenger the amount of mileages directly corresponding to the flight distance of the at least one flight segment, and reassigns to the passenger a mileage ticket with the changed airline.
